(19) United States
(12) Patent Application Publication
(10) Pub. No.: US 2025/0162340 A1
(43) Pub. Date: May 22, 2025

(54) THERMOSENSITIVE RECORDING MEDIUM

(71) Applicants: Laurence MODOLO, Wettolsheim (FR); Gaku KOHARA, Tokyo (JP); Victor GIUJUZZA, Wettolsheim (FR)

(72) Inventors: Laurence Modolo, Wettolsheim (FR); Gaku Kohara, Colmar (JP); Victor Giujuzza, Wettolsheim (FR)

(73) Assignee: Ricoh Company, Ltd., Tokyo (JP)

(21) Appl. No.: 18/836,854

(22) PCT Filed: Feb. 9, 2023
(86) PCT No.: PCT/JP2023/004428

§ 371 Date: Aug. 8, 2024

(30) Foreign Application Priority Data
Feb. 10, 2022 (EP) 22305146.7

(51) Int. Cl. B41M 5/44; B41M 5/323; B41M 5/41

(52) U.S. Cl. CPC B41M 5/44; B41M 5/323; B41M 5/41; B41M 2205/36; B41M 2205/38

(57) ABSTRACT

A thermosensitive recording medium includes at least: a synthetic resin film support layer; a thermosensitive colouring layer which contains a leuco dye and a developer; one or more protective layers which is/are laid down on the thermosensitive colouring layer, on the opposite side with respect to the synthetic resin film support layer, and one barrier backing layer which is laid down on the synthetic resin film support layer, on the opposite side with respect to the thermosensitive colouring layer. The barrier backing layer contains a polyvinyl alcohol characterized by a degree of saponification of at least 70%.

### TECHNICAL FIELD

The present invention relates to a thermosensitive recording medium.

### BACKGROUND ART

Thermosensitive recording media are known which use a colorant system wherein a dye, such as a leuco dye, in one layer of the medium (the thermosensitive coloring layer) reacts, upon the application of heat, with another component, a so-called “developer” in order to give rise to a coloured product.

Thermosensitive recording materials are used in a wide range of fields, including in-formation processing (output of an electronic desk calculator, or a computer), recorders for medical instrumentation, low speed and high speed facsimiles, automatic ticket benders (for railway tickets, or admission tickets), a thermosensitive copying, labels for a POS system, and tabs. For example, to satisfy the properties suitable for various uses, such as a label to be adhered to a surface of a moisture vapor resistant wrapping material, and a label capable of peeling after adhered once, thermosensitive recording materials are required to satisfy various properties, such as physical strength resistant to bending or breaking, dimensional stability, and water insolubility, at the same time. From these reasons, synthetic paper or synthetic resin films are often used as a support of a thermosensitive recording material.

In the fields of labels for POS system and tabs, especially, thermosensitive recording materials are often used with an adhesive layer provided on a back side thereof. There is a diverse range of the adhesives used for the back side, such as an adhesive intended for permanent bonding, an adhesive intended for releasing and re-adhering, and an adhesive capable of exhibiting adhesion at low temperature, which is used for a label for frozen food products.

In the case where synthetic paper or plastic film having higher smoothness than that of paper is used as a support, curling of a thermosensitive recording material may occur, especially when an adhesive layer is provided thereto. When a back layer is provided between a support and an adhesive layer, moreover, adhesion between the back layer and the support reduces, which may cause peeling from the portion at which the adhesion is weakened.

It has not yet been fully discovered why peeling or curling of a thermosensitive recording material occurs, but it is assumed that low molecular weight components, such as a plasticizer, a tackifier (a tackiness imparting agent), and an emulsifier, contained in an adhesive used in an adhesive layer migrate into a back layer or a support, in the case where a support is synthetic paper or a plastic film, to thereby reduce adhesion with the back layer, or to thereby impart plasticity to one side of the support.

PTL 1 provides a thermosensitive recording material, which contains: a support; a thermosensitive recording layer provided on one surface of the support; and a back layer provided on the other surface of the support, wherein the support has a surface formed of a resin, and wherein the back layer contains a combination of a core-shell acrylic resin and an oxazoline resin, and/or a reaction product thereof.

### CITATION LIST

### Patent Literature

[PTL 1] EP 2 675 626 A1

### SUMMARY OF INVENTION

### Technical Problem

The present invention aims to provide a thermosensitive recording medium, which has excellent adhesion between the support layer and a barrier backing layer, has excellent water resistance and stability of the barrier backing layer coating, and shows reduced curling of the barrier backing layer even when an adhesive is provided thereon. An anti-curl effect is particularly enhanced by the composition of the barrier backing layer composition of the present invention.

### Solution to Problem

In this context, the present invention relates to a thermosensitive recording medium (1) comprising at least:
a synthetic resin film support layer (10);
a thermosensitive colouring layer (40) which contains a leuco dye and a developer;
one or more protective layers (50) which is/are laid down on the thermosensitive colouring layer (40), on the opposite side with respect to the synthetic resin film support layer (10);
one barrier backing layer (20) which is laid down on the synthetic resin film support layer (10), on the opposite side with respect to the thermosensitive colouring layer (40),
wherein the barrier backing layer (20) contains a polyvinyl alcohol characterized by a degree of saponification of at least 70%.

In preferred embodiments of the present invention, the quantity of polyvinyl alcohol, expressed as dry weight with respect to 100% dry weight of all the components of the barrier backing layer (20) taken together, is at least 5%, more preferably at least 10%. Furthermore, the quantity of polyvinyl alcohol, expressed as dry weight with respect to 100% dry weight of all the components of the barrier backing layer (20) taken together, is preferably at most 40%, more preferably at most 30%, further more preferably at most 25%, still more preferably at most 20%, and most preferably at most 15%.

In preferred embodiments of the present invention, polyvinyl alcohol is used in the barrier backing layer (20) in combination with:
a core-shell type acrylic emulsion comprising a hydrophilic shell polymer including carboxylic acid and a hydrophobic core polymer; and
an oxazoline crosslinker.

In preferred embodiments of the present invention, the synthetic resin film support layer (10) has a thickness of at least 60 and at most 105 μm.

In preferred embodiments of the present invention, the synthetic resin film support layer (10) is biaxially oriented polypropylene (BOPP). Preferably, cavitated BOPP is used in support layer (10), having small cavities created during film manufacture. Without small cavities, BOPP may typically show a density slightly above 0.90 g/cm³. Low density cavitated BOPP with a density of 0.65 g/cm³ is available. It is preferred in the present invention to use cavitated BOPP with a density of at least 0.70 g/cm³ and at most 0.80 g/cm³. More preferably, the cavitated BOPP has a density of at least 0.72 g/cm³ and at most 0.79 g/cm³, particularly preferably at least 0.74 g/cm³ and at most 0.78 g/cm³. A BOPP film used as support layer (10) with a density in an appropriate range is considered to be able to contribute to image sensitivity and/or control of curl of thermosensitive recording media of the invention.

In preferred embodiments of the present invention, the synthetic resin film support layer (10) contains two protective layers (51) and (52).

In preferred embodiments of the present invention, the barrier backing layer (20) contains an antistatic agent.

### BRIEF DESCRIPTION OF DRAWINGS

FIG. 1 shows a method by which curl was evaluated, in the context of the present invention, for a thermosensitive recording material (thermosensitive recording medium) sample by applying a hotmelt glue on the barrier backing layer of the sample, fixed on a stem that is fixed straight on a support without contact between label and support, subjected to an environment of 50° C. and 70% relative humidity for 72 hours, where FIG. 1 is a frontal view.

FIG. 2 shows a method by which curl was evaluated, in the context of the present invention, for a thermosensitive recording material (thermosensitive recording medium) sample by applying a hotmelt glue on the barrier backing layer of the sample, fixed on a stem that is fixed straight on a support without contact between label and support, subjected to an environment of 50° C. and 70% relative humidity for 72 hours, where FIG. 2 is a view from the top.

FIG. 3 is a schematic representation of an illustrative, non-limiting example of a thermosensitive recording medium according to one embodiment of the present invention. In this type of embodiment, in the thermosensitive recording medium (1), the thermosensitive colouring layer (40), placed over synthetic resin film support layer (10), is in contact with the synthetic resin film support layer (10), and the thermosensitive colouring layer (40) is also in contact with the protective layer (50). On the opposite side of the synthetic resin film support layer (10) with respect to the thermosensitive colouring layer (40), there is a barrier backing layer (20).

FIG. 4 is a schematic representation of an illustrative, non-limiting example of a thermosensitive recording medium according to a further embodiment of the present invention. Here, in addition to the layers discussed above in relation to FIG. 3, an “under layer” (30) is present between the synthetic resin support layer (10) and thermal layer (40).

FIG. 5 is a schematic representation of an illustrative, non-limiting example of a thermosensitive recording medium according to a further embodiment of the present invention. Here, there is no “under layer” but, in addition to the layers discussed above in relation to FIG. 3, there are two protective layers (51) and (52).

FIG. 6 is a schematic representation of an illustrative, non-limiting example of a thermosensitive recording medium according to a further embodiment of the present invention. Here, there is an “under layer” (30) and there are two protective layers (51) and (52), in addition to the layers discussed above in relation to FIG. 3.

### DESCRIPTION OF EMBODIMENTS

### <Synthetic Resin Support Layer>

The support layer in the present invention is a support whose surface is formed of a resin, and examples thereof include synthetic paper formed mainly of a synthetic resin, a plastic film, laminate paper, and coat paper. Among them, synthetic paper is preferable.

The synthetic paper is appropriately selected depending on the intended purpose without any limitation, and examples thereof include: synthetic paper formed of synthetic fibers, such as polyethylene, polypropylene, polyethylene terephthalate, and polyamide; and a product obtained by binding the aforementioned synthetic paper to part of, a surface of, or both surfaces of paper.

The synthetic paper may be appropriately produced for use, or may be selected from commercial products. Examples of the commercial product thereof include polypropylene films such as biaxially oriented (bi-oriented) polypropylene (BOPP) films. Examples of appropriate polypropylene film products include: PL-100, product of Nan Ya Plastics, FPH-95 from YUPO CORPORATION, 100 LH344 from Jindal Films, SP-PG-10075 from Lichang Plastics.

The preferred thickness of the synthetic resin support layer in the present invention is at least 60 μm and at most 105 μm. A film thickness at the high end of this range, i.e. 105 μm, may be preferred to achieve a stiffness high enough to provide good label dispensing properties.

Moreover, the density of the support whose surface is formed of a resin is preferably 60 g/m³ to 150 g/m³. More preferably, the support is a low-density support of 60 g/m³ to 90 g/m³, as better coloring ability can be attained. When the support has low density, there are many air spaces within the support, which give excellent heat insulation effect, improving a coloring ability of a resulting thermosensitive recording material by effectively absorbing thermal energy applied from a thermal head with a thermosensitive recording layer. A preferred density is at least 70 g/m³ and at most 80 g/m³, preferably about 75 g/m³, in order to achieve the best balance between heat insulation and stiffness.

The wetting index of the surface of the support at the side of the back layer is preferably 0.03 N/m (30 dyn/cm) or greater, more preferably 0.04 N/m (40 dyn/cm) or greater. When the wetting index is less than 0.03 N/m (30 dyn/cm), it may be difficult to form a coating film of the back layer.

### <Undercoat Layer(s)>

In the technical field of thermosensitive recording media in general, the expression “undercoat” is understood by the skilled person to refer to the layer between the support and thermosensitive colouring layer. The expression “under layer” may also be used synonymously with “undercoat layer” by skilled persons in the field.

In the present invention, an undercoat layer may be provided or not i.e. the undercoat layer is merely an option in the present invention, and the thermosensitive recording medium of the present invention may or may not contain such an undercoat layer.

In the thermosensitive recording medium of the present invention, if an undercoat layer is used, the technical effect sought after through its use may notably be to improve weakness of adhesion between the substrate and the thermal layer, or to improve printing quality.

As mentioned above, the thermosensitive recording medium of the present invention may optionally contain an undercoat layer disposed between the support and the thermosensitive colouring layer.

If present in the thermosensitive recording medium of the present invention, the undercoat layer contains a binder resin, and the undercoat layer may further contain other components such as a filler, and other additives.

As for the binder resin to be used in an undercoat layer, either of a water-dispersible resin or a water-soluble resin may be used. Specific examples thereof include conven-tionally known water-soluble polymers, and aqueous polymer emulsions.

The water-soluble polymer that may be used in the binder resin in an undercoat layer may be suitably selected depending on the intended purpose without any restriction. Examples thereof include polyvinyl alcohol, starch and derivatives thereof, cellulose derivatives such as methoxy cellulose, hydroxy ethyl cellulose, carboxy methyl cellulose, methyl cellulose and ethyl cellulose, polyvinyl pyrrolidone, alkali salts of styrene-maleic anhydride copolymers, alkali salts of isobutylene-maleic anhydride copolymers, alginate soda, gelatin and casein. These may be used alone or in combination.

The aqueous polymer emulsion that may be used in the binder resin in an undercoat layer may be suitably selected depending on the intended purpose without any restriction. Examples thereof include latexes of, for example, styrene-butadiene copolymers; and emulsions of, for example, vinyl acetate resins, acryl-based resins and polyurethane resins. These may be used alone or in combination.

An inorganic filler may be used or may be omitted from an undercoat layer if an undercoat layer is used in the thermosensitive recording medium of the present invention. If an inorganic filler is used, examples thereof include aluminum hydroxide, calcium carbonate, aluminum oxide, zinc oxide, titanium dioxide, silica, barium sulfate, talc, kaolin, alumina and clay. These may be used alone or in combination. Among these, aluminum hydroxide, calcium carbonate, kaolin and clay are preferable in terms of liquid properties in a coating liquid, stability of dispersed particles, and water solubility.

As components contained in undercoat layers of thermosensitive recording media, it is known, in order to improve printing quality, to use hollow particles having a hollow ratio of 50% or more or indeed 80% or more, or 90% or more, wherein the hollow ratio (in %) is the (inner diameter of a hollow particle/outer diameter of the hollow particle)×100. Each of such hollow particles may have a shell made of a thermoplastic resin and contain therein air or other gas, typically with a volume average particle diameter of 1 μm to 10 μm, most commonly having a thermoplastic resin as a shell, made from polystyrene, polyvinyl chloride, polyvinylidene chloride, polyvinyl acetate, polyacrylic ester, polyacrylonitrile, and polybutadiene, and copolymer resins thereof.

If an undercoat layer is used in the thermosensitive recording medium of the present invention, the deposition amount of a first undercoat layer in the thermosensitive recording medium is appropriately 0.4 g/m² to 10 g/m², more preferably 0.6 g/m² to 4 g/m².

Generally speaking, a key function of an undercoat layer in a conventional thermosensitive recording medium is to fill up and compensate for the non-uniformity of supports such as paper supports in particular. Generally such an undercoat layer is chosen, through its constituents, to be a low-cost layer which ensures a smoother surface before coating with the thermal layer which is expensive-such a way of proceeding optimizes the use of and avoids loss of thermal layer materials. Undercoat layers have been modified to improve pre-print properties and sensitivity by adding hollow fillers which reflect the heat to thermosensitive colouring layer rather than the latter being lost to the paper support layer. In the present invention however, due to the high smoothness of the synthetic resin film support layer in comparison to paper supports for other thermosensitive recording media, an undercoat layer is not normally necessary. Consequently, in one preferred embodiment of the present invention, one side of the synthetic resin film support layer is in contact with one side of the thermosensitive layer, without any undercoat layer between the synthetic resin film support layer and the thermosensitive colouring layer. In the present invention, where the base layer in the thermosensitive recording medium is a synthetic resin film support layer in the form of a polymeric thin film, an undercoat layer may however still be used to effectively utilize generated heat for higher sensitivity, improve adhesiveness between the support and the thermosensitive layer, and prevent permeation of the recording layer materials into the support.

### <Thermosensitive Colouring Layer>

In the thermosensitive recording medium of the present invention, the thermosensitive colouring layer is situated over the support layer, and the thermosensitive colouring layer contains a leuco dye, a developer and a hydrophobic resin. The thermosensitive colouring layer may be in contact with one face of the synthetic resin film support layer or alternatively, as discussed above, an undercoat layer may be present between the support layer and the thermosensitive colouring layer.

### <<Thermosensitive Colouring Layer-Leuco Dye and Developer>>

The thermosensitive colouring layer contains a colorant system wherein a a leuco dye, in one layer of the medium reacts, upon the application of heat, with another component, a so-called “developer”, in order to give rise to a coloured product.

The leuco dye is a compound exhibiting electron donation properties, and may be used singly or in combination of two or more species. However, the leuco dye itself is a colourless or light-coloured dye precursor, and commonly known leuco compounds can be used. Examples of the leuco compounds include triphenylmethane phthalide compounds, triarylmethane compounds, fluoran compounds, phenothiazinc compounds, thiofluoran compounds, xanthen compounds, indophthalyl compounds, spiropyran compounds, azaphthalide compounds, chlormenopirazole compounds, methyne compounds, rhodamine anilinolactum compounds, rhodamine lactum compounds, quinazoline compounds, diazaxanthen compounds, bislactone compounds. In consideration of colouring property, fogging of the background, and colour fading of the image due to moisture, heat or light radiation, specific examples of such compounds are as follows: 2-anilino-3-methyl-6-diethyl amino fluoran, 2-anilino-3-methyl-6-(di-n-butyl amino) fluoran, 2-anilino-3-methyl-6-(di-n-pentyl amino) fluoran, 2-anilino-3-methyl-6-(N-n-propyl-N-methyl amino) fluoran, 2-anilino-3-methyl-6-(N-isopropyl-N-methyl amino) fluoran, 2-anilino-3-methyl-6-(N-isobutyl-N-methyl amino) fluoran, 2-anilino-3-methyl-6-(N-n-amyl-N-methyl amino) fluoran, 2-anilino-3-methyl-6-(N-sec-butyl-N-ethyl amino) fluoran, 2-anilino-3-methyl-6-(N-n-amyl-N-ethyl amino) fluoran, 2-anilino-3-methyl-6-(N-iso-amyl-N-ethyl amino) fluoran, 2-anilino-3-methyl-6-(N-cyclohexyl-N-methyl amino) fluoran, 2-anilino-3-methyl-6-(N-ethyl-p-toluidino) fluoran, 2-anilino-3-methyl-6-(N-methyl-p-toluidino) fluoran, 2-(m-trichloro methyl anilino)-3-methyl-6-diethyl amino fluoran, 2-(m-trifluoro methyl anilino)-3-methyl-6-diethyl amino fluoran, 2-(m-trifluoro methyl anilino)-3-methyl-6-(N-cyclohexyl-N-methyl amino) fluoran, 2-(2,4-dimethyl anilino)-3-methyl-6-diethyl amino fluoran, 2-(N-ethyl-p-toluidino)-3-methyl-6-(N-ethyl anilino) fluoran, 2-(N-methyl-p-toluidino)-3-methyl-6-(N-propyl-p-toluidino) fluoran, 2-anilino-6-(N-n-hexyl-N-ethyl amino) fluoran, 2-(o-chloranilino)-6-diethyl amino fluoran, 2-(o-bromoanilino)-6-diethyl amino fluoran, 2-(o-chloranilino)-6-dibutyl amino fluoran, 2-(o-fluoroanilino)-6-dibutyl amino fluoran, 2-(m-trifluoro methyl anilino)-6-diethylamino fluoran, 2-(p-acetyl anilino)-6-(N-n-amyl-N-n-butyl amino) fluoran, 2-benzyl amino-6-(N-ethyl-p-toluidino) fluoran, 2-benzyl amino-6-(N-methyl-2,4-dimethyl anilino) fluoran, 2-benzyl amino-6-(N-ethyl-2,4-dimethyl anilino) fluoran, 2-dibenzyl amino-6-(N-methyl-p-toluidino) fluoran, 2-dibenzyl amino-6-(N-ethyl-p-toluidino) fluoran, 2-(di-p-methyl benzyl amino)-6-(N-ethyl-p-toluidino) fluoran, 2-(a-phenyl ethyl amino)-6-(N-ethyl-p-toluidino) fluoran, 2-methyl amino-6-(N-methyl anilino) fluoran, 2-methyl amino-6-(N-ethyl anilino) fluoran, 2-methylamino-6-(N-propyl anilino) fluoran, 2-ethyl amino-6-(N-methyl-p-toluidino) fluoran, 2-methyl amino-6-(N-methyl-2,4-dimethyl anilino) fluoran, 2-ethyl amino-6-(N-methyl-2,4-dimethyl anilino) fluoran, 2-dimethyl amino-6-(N-methyl anilino) fluoran, 2-dimethyl amino-6-(N-ethyl anilino) fluoran, 2-diethyl amino-6-(N-methyl-p-toluidino) fluoran, benzo leuco methylene blue, 2-[3,6-bis(diethylamino)]-6-(o-chloranilino) xanthyl benzoic acid lactum, 2-[3,6-bis(diethyl amino)]-9-(o-chloranilino) xanthyl benzoic acid lactum, 3,3-bis(p-dimethyl amino phenyl) phthalide, 3,3-bis(p-dimethyl amino phenyl)-6-dimethyl amino phthalide, 3,3-bis(p-dimethyl amino phenyl)-6-diethyl amino phthalide, 3,3-bis(p-dimethyl amino phenyl)-6-chlorphthalide, 3,3-bis(p-dibutyl amino phenyl) phthalide, 3-(2-methoxy-4-dimethyl amino phenyl)-3-(2-hydroxy-4,5-dichlorophenyl) phthalide, 3-(2-hydroxy-4-dimethyl amino phenyl)-3-(2-methoxy-5-chlorophenyl) phthalide, 3-(2-hydroxy-4-dimethoxy amino phenyl)-3-(2-methoxy-5-chlorophenyl) phthalide, 3-(2-hydroxy-4-dimethoxy amino phenyl)-3-(2-methoxy-5-nitrophenyl) phthalide, 3-(2-hydroxy-4-diethyl amino phenyl)-3-(2-methoxy-5-methyl phenyl) phthalide, 3,6-bis(dimethyl amino) fluo-renespiro (9,3′)-6′-dimethyl amino phthalide, 6′-chloro-8′-methoxy-benzoindolino spiropyran, and 6′-bromo-2′-methoxy benzoindolino spiropyran. These may be used alone or in combination.

The amount of the leuco dye contained in the thermosensitive coloring layer is preferably 3% by mass to 20% by mass.

As the developer, various electron accepting materials are suitably used to react with the aforementioned leuco dye at the time of heating so as to develop colours. Examples thereof include phenolic compounds, organic or inorganic acidic compounds and esters or salts thereof. Specific examples thereof include: bisphenol A, tetrabromobisphenol A, gallic acid, salicylic acid, 3-isopropyl salicylate, 3-cyclohexyl salicylate, 3-5-di-tert-butyl salicylate, 3,5-di-α-methyl benzyl salicylate, 4,4′-isopropylidenediphenol, 1,1′-isopropylidene bis(2-chlorophenol), 4,4′-isopropylidene bis(2,6-dibromophenol), 4,4′-isopropylidenc bis (2,6-dichlorophenol), 4,4′-isopropylidene bis(2-methyl phenol), 4,4′-isopropylidenc bis(2,6-dimethyl phenol), 4,4′-isopropylidene bis(2-tert-butyl phenol), 4,4′-sec-butylidene diphenol, 4,4′-cyclohexylidene bisphenol, 4,4′-cyclohexylidene bis (2-methyl phenol), 4-tert-butyl phenol, 4-phenyl phenol, 4-hydroxy diphenoxide, α-naphthol, β-naphthol, 3,5-xylenol, thymol, methyl-4-hydroxybenzoate, 4-hydroxyacetophenone, novolak phenol resins, 2,2′-thio bis(4,6-dichloro phenol), catechol, resorcin, hydroquinone, pyrogallol, fluoroglycine, fluoroglycine carboxylate, 4-tert-octyl catechol, 2,2′-methylene bis(4-chlorophenol), 2,2′-methylene bis (4-methyl-6-tert-butyl phenol), 2,2′-dihydroxy diphenyl, ethyl p-hydroxybenzoate, propyl p-hydroxybenzoate, butyl p-hydroxybenzoate, benzyl p-hydroxybenzoate, p-hydroxybenzoate-p-chlorobenzyl, p-hydroxybenzoate-o-chlorobenzyl, p-hydroxybenzoate-p-methylbenzyl, p-hydroxybenzoate-n-octyl, benzoic acid, zinc salicylate, 1-hydroxy-2-naphthoic acid, 2-hydroxy-6-naphthoic acid, 2-hydroxy-6-zinc naphthoate, 4-hydroxy diphenyl sulphone, 4-hydroxy-4′-chloro diphenyl sulfone, bis (4-hydroxy phenyl) sulfide, 2-hydroxy-p-toluic acid, 3, 5-di-tert-zinc butyl salicylate, 3,5-di-tert-tin butyl salicylate, tartaric acid, oxalic acid, maleic acid, citric acid, succinic acid, stearic acid, 4-hydroxyphthalic acid, boric acid, thiourea derivatives, 4-hydroxy thiophenol derivatives, bis(4-hydroxyphenyl) acetate, bis (4-hydroxyphenyl) ethyl acetate, bis(4-hydroxyphenyl) acetate-n-propyl, bis (4-hydroxyphenyl) acetate-n-butyl, bis(4-hydroxyphenyl) phenyl acetate, bis (4-hydroxyphenyl) benzyl acetate, bis(4-hydroxyphenyl) phenethyl acetate, bis (3-methyl-4-hydroxyphenyl) acetate, bis(3-methyl-4-hydroxyphenyl) methyl acetate, bis(3-methyl-4-hydroxyphenyl) acetate-n-propyl, 1,7-bis(4-hydroxyphenylthio) 3,5-dioxaheptane, 1,5-bis(4-hydroxyphenylthio) 3-oxaheptane, 4-hydroxy phthalate dimethyl, 4-hydroxy-4′-methoxy diphenyl sulfone, 4-hydroxy-4′-ethoxy diphenyl sulfone, 4-hydroxy-4′-isopropoxy diphenyl sulfone, 4-hydroxy-4′-propoxy diphenyl sulfone, 4-hydroxy-4′-butoxy diphenyl sulfone, 4-hydroxy-4′-isopropoxy diphenyl sulfone, 4-hydroxy-4′-sec-butoxy diphenyl sulfone, 4-hydroxy-4′-tert-butoxy diphenyl sulfone, 4-hydroxy-4′-benzyloxy diphenyl sulfone, 4-hydroxy-4′-phenoxy diphenyl sulfone, 4-hydroxy-4′-(m-methyl benzoxy) diphenyl sulfone, 4-hydroxy-4′-(p-methyl benzoxy)diphenyl sulfone, 4-hydroxy-4′-(o-methyl benzoxy) diphenyl sulfone, 4-hydroxy-4′-(p-chloro benzoxy) diphenyl sulfone, 4-hydroxy-4′-oxyaryl diphenyl sulfone, 4-hydroxy-4-allyloxy diphenyl sulfone, N-(2-((phenylcarbamoyl) amino) phenyl) benzene sulfonamide, 4,4′-sulfonylbisphenol, polymer with 1,1′-oxybis [2-chloroethane], 2-(4-Hydroxyphenylsulfonyl) phenol, (Bis(3-allyl-4-hydroxyphenyl) sulfone), 2,2′-diallyl-4,4′-sulfonyldiphenol. These may be used alone or in combination.

In the thermosensitive colouring layer, the mixing ratio of the developer to the leuco dye is such that the developer is preferably 0.5 parts by mass to 10 parts by mass, more preferably 1 part by mass to 5 parts by mass, relative to 1 part by mass of the leuco dye.

The thickness of the thermosensitive coloring layer varies depending on the composition of the thermosensitive coloring layer and intended use of the thermosensitive recording medium and cannot be specified flatly, but it is preferably 1 μm to 50 μm, more preferably 2 μm to 20 μm.

Besides the above-described leuco dye and developer, it is possible to appropriately add, to the thermosensitive coloring layer, other materials customarily used in thermosensitive recording materials, such as a binder, a filler, a hot-meltable material, a crosslinking agent, a pigment, a surfactant, a fluorescent whitening agent and a lubricant.

The binder may be used if necessary in order to improve the adhesiveness and coatability of the layer. The binder is suitably selected depending on the intended purpose without any restriction. Specific examples of the binder resin include starches, hydroxyethyl cellulose, methyl cellulose, carboxy methyl cellulose, gelatin, casein, gum arabic, polyvinyl alcohols, salts of diisobutylene-maleic anhydride copolymers, salts of styrene-maleic anhydride copolymers, salts of ethylene-acrylic acid copolymers, salts of styrene-acryl copolymers and salt emulsions of styrene-butadiene copolymers. These binders may be used alone or in combination. A preferred binder preparation for the thermosensitive coloring layer in the present invention is a combination of polyvinyl alcohol and aliphatic polyurethane.

The filler is suitably selected depending on the intended purpose without any restriction. Examples thereof include inorganic pigments such as calcium carbonate, aluminum oxide, zinc oxide, titanium dioxide, silica, aluminum hydroxide, barium sulfate, talc, kaolin, alumina and clay, and commonly known organic pigments. Among these, acidic pigments (those which exhibit acidity in aqueous solutions) such as silica, alumina and kaolin are preferable, with silica being particularly preferable from the viewpoint of developed color density.

The hot-meltable material is suitably selected depending on the intended purpose without any restriction. Examples thereof include fatty acids such as stearic acid and behenic acid; fatty acid amides such as stearic acid amide, erucic acid amide, palmitic acid amide, behenic acid amide and palmitic acid amide; N-substituted amides such as N-lauryl lauric acid amide, N-stearyl stearic acid amide and N-oleyl stearic acid amid; bis fatty acid amides such as methylene bis stearic acid amide, ethylene bis stearic acid amide, ethylene bis lauric acid amide, ethylene bis capric acid amide and ethylene bis behenic acid amide; hydroxyl fatty acid amides such as hydroxyl stearic acid amide, methylene bis hydroxyl stearic acid amide, ethylene bis hydroxyl stearic acid amide and hexamethylene bis hydroxy stearic acid amide; metal salts of fatty acids, such as zinc stearate, aluminum stearate, calcium stearate, zinc palmitate and zinc behenate; p-benzyl biphenyl, terphenyl, triphenyl methane, benzyl p-benzyloxybenzoate, β-benzyloxy naphthalene, phenyl β-naphthoate, 1-hydroxy-2-phenyl naphthoate, methyl 1-hydroxy-2-naphthoate, diphenyl carbonate, benzyl terephthalate, 1,4-dimethoxy naphthalene, 1,4-diethoxy naphthalene, 1,4-dibenzyloxy naphthalene, 1,2-diphenoxy ethane, 1,2-bis(4-methyl phenoxy ethane), 1,4-diphenoxy-2-butene, 1,2-bis (4-methoxy phenyl thio) ethane, dibenzoyl methane, 1,4-diphenylthio butane, 1,4-diphenylthio-2-butene, 1,3-bis(2-vinyloxy ethoxy) benzene, 1,4-bis(2-vinyloxy ethoxy) benzene, p-(2-vinyloxy ethoxy) biphenyl, p-aryloxy biphenyl, dibenzoy-loxymethane, dibenzoyloxypropane, dibenzyl sulfide, 1,1-diphenyl ethanol, 1,1-diphenyl propanol, p-benzyloxy benzyl alcohol, 1,3-phenoxy-2-propanol, N-octadecyl carbamoyl-p-methoxy carbonyl benzene, N-octadecyl carbamoyl benzene, 1,2-bis(4-methoxyphenoxy) propane, 1,5-bis(4-methoxyphenoxy)-3-oxapentane, dibenzyl oxalate, bis(4-methyl benzyl) oxalate and bis(4-chlorobenzyl) oxalate. These may be used alone or in combination.

Further, it is commonly preferred that diacetone-modified polyvinyl alcohol be incorporated into the thermosensitive coloring layer, when N-aminopolyacryl amide serving as a crosslinking agent is added to the thermosensitive coloring layer and the protective layer, a crosslinking reaction readily occurs, and water resistance can be improved without adding another crosslinking agent that could impede color de-velopment.

When synthetic paper is used as a support layer, a combination of polyvinyl alcohol and aliphatic urethane dispersion is preferred to enhance adhesion of all layers to synthetic paper support, as mentioned above in relation to binder options for the thermosensitive coloring layer.

The thermosensitive coloring layer can be formed by commonly known methods. For example, a leuco dye and a developer have been pulverized and dispersed with a binder and other components so as to have a particle diameter of 1 μm to 3 μm by a disperser such as a ball mill, an Atriter and a sand mill. The resultant dispersions are mixed, if necessary, together with a filler and a hot-meltable material (sensitizer) dispersion liquid in accordance with a predetermined formulation, to thereby prepare a coating liquid of a thermosensitive coloring layer, followed by applying the thus-prepared coating liquid onto a support.

### <Protective Layer(s)>

In order to achieve good matching properties to thermal head like no sticking, no scratches as well as various qualities such as water or plasticizer resistance, it is preferable to provide at least one protective layer on the thermosensitive layer. Several different protective layers can be overlaid on each other to focus respectively more on matching or barrier properties. The protective layer(s) in the thermosensitive recording medium of the present invention may be suitably selected depending on the intended purpose without any particular restriction.

The protective layer(s) typically contain(s) at least a binder, and each of the protective layer(s) may contain a cross-linking agent, an inorganic filler, a lubricant and a surfactant.

The binder of (each of) the protective layer(s) is suitably selected depending on the intended purpose without any restriction, it being possible to use the same binder in each protective layer or a different binder in separate protective layers. Examples of binders that may be used in the protective layer(s) include polyvinyl alcohol, modified polyvinyl alcohol, starch and derivatives thereof, cellulose derivatives, polyvinylpyrrolidone, polyethyleneimine, alginate soda, gelatin and casein. Acrylic binders may also be used. Hydrophobic resins that may be used as binders in the protective layer(s) include ones typically provided as aqueous emulsions during preparation of the protective layer(s), such as urethane resins, epoxy resins, vinyl acetate (co) polymers, vinylidene chloride (co) polymers, vinyl chloride (co) polymers, and styrene-butadiene copolymers.

The cross-linking agent is not particularly limited so long as the cross-linking agent can reduce water-solubility of the binder by reacting with the binder. Examples of the cross-linking agent include glyoxal derivatives, methylol derivatives, epichlorohydrin, polyamide epichlorohydrin, epoxy compounds, aziridine compounds, hydrazine, hydrazide derivatives, oxazoline derivatives, and carbodiimide derivatives. One of these cross-linking agents may be used alone or two or more of these cross-linking agents may be used in combination. Among these cross-linking agents, polyamide epichlorohydrin is preferable because polyamide epichlorohydrin is highly safe in handling and takes a short curing time needed for water-resistance treatment. The content of polyamide epichlorohydrin is not particularly limited, may be appropriately selected depending on the intended purpose, and is preferably 10 parts by mass or greater but 80 parts by mass or less and more preferably 20 parts by mass or greater but 60 parts by mass or less relative to 100 parts by mass of the binder.

The thickness of the protective layer(s) varies preferably 0.2 μm to 10 μm, more preferably 0.5 μm to 5 μm. In non-limiting exemplary embodiments for this invention, a protective layer of thickness 2.5 μm when dry can be used-when added during the manufacturing process the initial wet thickness of this layer is approximately 6 μm. In the event that several protective layers are applied, lower individual thicknesses for each one will be required. A preferred maximum cumulative thickness for the sum of all protective layers is 10 μm for the dried final product.

The inorganic filler in the protective layer(s), if used, is suitably selected depending on the intended purpose without any restriction. Examples the inorganic filler include aluminum hydroxide, calcium carbonate, aluminum oxide, zinc oxide, titanium dioxide, silica, barium sulfate, talc, kaolin, alumina and clay. These may be used alone or in combination. Among these, aluminum hydroxide, and calcium carbonate are particularly preferable because the protective layer containing such inorganic filler is provided with excellent abrasion resistance with respect to a thermal head when printing is performed for a long period of time. The amount of the inorganic filler in the second protective layer is suitably selected depending on the intended purpose without any restriction. The amount of the inorganic filler depends on types of the filler, but it is preferably 50 parts by mass to 500 parts by mass, relative to 100 parts by mass of the binder resin.

The lubricant, if used, is suitably selected depending on the intended purpose without any restriction. Examples thereof include higher fatty acids such as zinc stearate, calcium stearate, montanate wax, polyethylene wax, carnauba wax, paraffin wax, ester wax and metal salts thereof; higher fatty acid amides, higher fatty acid esters, animal wax, vegetable wax, mineral wax, and petroleum wax.

The surfactant is not particularly limited and may be appropriately selected depending on the intended purpose. Examples of the surfactant include anionic surfactants, nonionic surfactants, amphoteric surfactants, and fluorosurfactants. One of these surfactants may be used alone or two or more of these surfactants may be used in combination. Examples of the anionic surfactant include polyoxyethylene alkyl ether acetate, dodecylbenzene sulfonate, laurate, and polyoxyethylene alkyl ether sulfate salt. One of these anionic surfactants may be used alone or two or more of these anionic surfactants may be used in combination. Examples of the nonionic surfactant include acetylene glycol-based surfactants, polyoxyethylene alkyl ether, polyoxyethylene alkyl phenyl ether, polyoxyethylene alkyl ester, and polyoxyethylene sorbitan fatty acid ester. One of these nonionic surfactants may be used alone or two or more of these nonionic surfactants may be used in combination. Examples of the acetylene glycol-based surfactant include 2,4,7,9-tetramethyl-5-decyne-4,7-diol, 3,6-dimethyl-4-octyne-3,6-diol, 3,5-dimethyl-1-hexyne-3-diol, and 2,5,8,11-tetramethyl-6-dodecyne-5,8-diol. One of these acetylene glycol-based surfactants may be used alone or two or more of these acetylene glycol-based surfactants may be used in combination.

A method for forming the first, second or subsequent protective layer is suitably selected depending on the intended purpose without any restriction. Examples thereof include blade coating, roll coating, wire bar coating, die coating, and curtain coating.

### <Intermediate Layer>

An intermediate layer is a layer that may be provided between the thermosensitive colouring layer and the protective layer. Such an intermediate layer is however not required in the present invention, but instead is only optional.

An intermediate layer containing a water-soluble resin can prevent the thermosensitive recording layer from being colored due to ultraviolet irradiation performed for forming the protective layer, or a reaction between the protective layer and pigments from the thermosensitive colouring layer. An intermediate layer, similar to a first protective layer may also improve background resistance.

An intermediate layer, if used, contains a water-soluble resin. The water-soluble resin is not particularly limited and may be appropriately selected depending on the intended purpose. Examples of the water-soluble resin include: polyvinyl alcohol resins, starch or derivatives of starch; cellulose derivatives such as hydroxymethyl cellulose, hydroxyethyl cellulose, carboxymethyl cellulose, methyl cellulose, and ethyl cellulose; water-soluble polymers such as sodium polyacrylate, polyvinyl pyrrolidone, acrylamide-acrylic acid ester copolymers, acrylamide-acrylic acid ester-methacrylic acid terpolymers, styrene-maleic anhydride copolymer alkali salts, isobutylene-maleic anhydride copolymer alkali salts, polyacrylamide, sodium alginate, gelatin, and casein; emulsions of, for example, polyvinyl acetate, polyurethane, polyacrylic acid, polyacrylic acid ester, vinyl chloride-vinyl acetate copolymers, polybutyl methacrylate, and ethylene-vinyl acetate copolymers; and latexes of, for example, styrene-butadiene copolymers and styrene-butadiene-acrylic copolymers. One of these water-soluble resins may be used alone or two or more of these water-soluble resins may be used in combination. Among these water-soluble resins, polyvinyl alcohol resins are preferable, and polyvinyl alcohol resins having a molecular weight of 15,000 or less are more preferable.

Other components of an intermediate layer are not particularly limited and may be appropriately selected depending on the intended purpose. Examples of the other components include a cross-linking agent and a surfactant. One of these other components may be used alone or two or more of these other components may be used in combination. Both the cross-linking agents and surfactants that can be used in a possible intermediate layer can be chosen among the same types as listed above for protective layers.

The method for forming the intermediate layer is not particularly limited and may be appropriately selected depending on the intended purpose. For example, the intermediate layer can be formed through the step (1) and the step (2) described below.
Step (1): The water-soluble resin, and as needed, the cross-linking agent and the surfactant are mixed, to prepare an intermediate layer coating liquid.
Step (2): The intermediate layer coating liquid is coated over the thermosensitive recording layer and dried.

The coating method is not particularly limited and may be appropriately selected depending on the intended purpose. Examples of the coating method include a blade coating method, a gravure coating method, a gravure offset coating method, a bar coating method, a roll coating method, a knife coating method, an air knife coating method, a comma coating method, a U-comma coating method, an AKKU coating method, a smoothing coating method, a microgravure coating method, a reverse roll coating method, a 4-roll or 5-roll coating method, a dip coating method, a curtain coating method, a slide coating method, and a die coating method.

The amount of the intermediate layer remaining attached after drying is not particularly limited, may be appropriately selected depending on the intended purpose, and is preferably, for example, 0.4 g/m² or greater but 3.0 g/m² or less, more preferably 0.5 g/m² or greater but 1.5 g/m² or less, and particularly preferably 0.5 g/m² or greater but 1.0 g/m² or less.

### <Barrier Backing Layer>

A barrier backing layer is provided under the support layer in the thermosensitive recording medium of the present invention, thus disposed on the surface of the support opposite to the surface thereof where the thermosensitive layer is disposed, or opposite to where the undercoat layer between the support and the thermosensitive layer is situated, if such an undercoat layer is present.

The barrier backing layer contains polyvinyl alcohol (PVA). In the present invention, “polyvinyl alcohol” is taken to encompass modified polyvinyl alcohols as commonly used by persons skilled in the art. Polyvinyl alcohol is often prepared industrially by polymerisation of vinyl acetate followed by saponification (ester hydrolysis), so that a certain percentage of (—CH₂—CHO—CO-Me) groups are present, in addition to the main monomer residue of (—CH₂—CHOH—). In polyvinyl alcohols, and which can be used in the barrier backing layer in a thermosensitive recording medium of the present invention, the saponification range is at least 70%, and typically from 70% to 99%, i.e. the polymer chain contains 70% to 99% of (—CH₂—CHOH—) units. It has been observed in the framework of the present invention that the use of a barrier backing layer containing polyvinyl alcohol with a saponification (ester hydrolysis) degree of less than 70% may give rise to thermosensitive recording media with low curl resistance.

In the present invention, the degree of polymerization of the polyvinyl alcohol is not particularly restricted and may for example range between 400 and 2000, i.e. there are between 400 and 2000 monomer units in the polymer chain on average. As explained above, for a perfect PVA homopolymer, all such monomer units would be (—CH₂—CHOH—). However, typically PVA materials sold commercially and used by persons skilled in the art contain a certain degree of residual ester groups and/or other main chain or side-chain modifications.

In the context of the present invention, it is possible to use polyvinyl alcohol products in the barrier backing layer which result from copolymerization of vinyl acetate with other monomers, such as itaconic acid, which gives rise to (—CH₂—C(CO₂ M) (CH₂CO₂M)-) monomer residues in the polymer chain (M=H or a metal ion such as Na according to the pH/degree of neutralization). Other modified PVAs that can be used in the present invention include sulfonic modified PVAs, diacetonic modified PVAs, and acetoacetyl modified PVAs. Another type of modified PVA that can be used in the barrier backing layer of thermosensitive recording media of the present invention is an amide-modified PVA. A non-limiting example of an appropriate amide-modified PVA in this context is a saponified copolymer of N-(2-acetyl-1,1-dimethyl) ethylacrylamide, vinyl alcohol and vinyl acetate having the following structure:

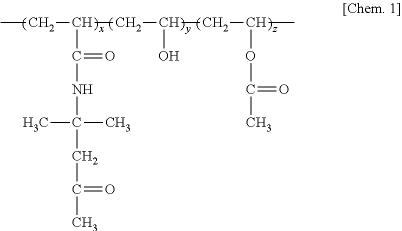

Such an amide-modified PVA is sold by Japan VAM & POVAL Co., LTD. As the product DM-17.

In the present invention, the barrier backing layer may contain substantially only or only PVAs, including modified PVAs, as water-soluble resin. However, other polymers can be used in conjunction with the PVAs used in the barrier backing layer of the present invention. Other polymers that can be used conjointly with PVAs include latexes of, for example, styrene-butadiene copolymers; and emulsions of, for example, vinyl acetate resins, acryl-based resins (e.g. acrylic acid-acrylic acid ester copolymer latexes), (meth)acrylamide-based resins, and polyurethane resins.

In a particular embodiment that has been found effective to improve back anchorage, the polyvinyl alcohol is used in the barrier backing layer in combination with:
a core-shell type acrylic emulsion comprising a hydrophilic shell polymer including carboxylic acid and a hydrophobic core polymer; and
an oxazoline crosslinker.

The core-shell type acrylic emulsion is preferably a core-shell acrylic resin containing a core including as an essential component a polymer material containing an extremely hydrophilic group, such as an acrylonitrile group; and a shell containing as an essential component a copolymer of a hydrophilic polymer material, such as methacrylamide, and (meth)acrylic acid. The core-shell acrylic resin, after subjected to crosslinking treatment with a certain crosslinking agent, has excellent barrier properties, water resistance, and film-forming ability.

Such a core-shell acrylic resin has been known in the art through JP-A Nos. 06-227119, 09-254555, and 2000-158815. For example, a commercial product on the market under the name of BARIASTAR (manufactured by Mitsui Chemicals, Inc.) can be used as the core-shell acrylic resin.

The oxazoline resin has a molecular structure having a polymer chain (acryl or styrene) as a principle chain, and oxazoline groups, which are weak Lewis bases, grafted to the polymer chain. The oxazoline group is bonded to the core-shell acrylic resin by a crosslink reaction, or graft copolymerization through various reactions with carboxyl groups present on a surface of the core-shell acrylic resin, such as cleaving a ring structure of the oxazoline group to bond to a carboxyl group, and bonding to a carboxyl group, as it is. As a result, barrier properties, water resistance, solvent resistance, heat resistance, and strength are improved. The oxazoline resin is in particular very effective for preventing peeling of the back layer due to low molecular weight substances, such as emulsifiers or tackifiers. The oxazoline resin is highly reactive with a carboxyl group, but the reactivity thereof at ambient temperature is lower than that of an aziridine group, and improves stability of a back layer coating liquid as gelation is inhibited.

In the present invention, the quantity of polyvinyl alcohol, expressed as dry weight with respect to 100% dry weight of all the components of the barrier backing layer (20) taken together, is preferably at least 5%, more preferably at least 10%, in order to observe effective properties of curl resistance. In order to also optimize water resistance, the quantity of polyvinyl alcohol, expressed as dry weight with respect to 100% dry weight of all the components of the barrier backing layer (20) taken together, is preferably at most 40%, more preferably at most 25%, and still more preferably at most 20%, even more preferably at most 15%.

In a preferred embodiment, the barrier backing layer may contain an antistatic agent.

As optional antistatic agent filler for the barrier backing layer, the latter may, for example, be selected from commonly used ion-conducting antistatic agents and electron-conducting antistatic agents. Specific examples of the ion-conducting antistatic agents include inorganic salts such as sodium chloride; anionic polymers such as sodium polystyrenesulfonate; and resins containing quaternary ammonium salts that are electrolyte cations. Specific examples of the electron-conducting antistatic agents include conductive metal compounds such as conductive metal oxides, for example conductive tin and antimony oxides; and conductive polymers such as polyaniline. Antistatic agent using a surfactant may also be used. Among these antistatic agents, polystyrene sulfonic acid salts, in particular, react with aziridine, thereby improving water resistance obtained by means of cross-linkage. Additionally, salts which have copolymerized with maleic acid are effective in that they have antistatic properties and also improve water resistance.

Antistatic agents based on a surfactant are available at relatively low cost, in wide varieties, and have excellent antistatic properties. However, most of the antistatic agents using the surfactant realize the conductivity by absorption of moisture by the surfactant itself. Moreover, most of the electric conductive metal oxides are highly hy-droscopic. Accordingly, these antistatic agents tend to be influenced by humidity, and may lower water resistance of a resulting back layer. An antistatic agent using acrylic polymer has the advantage that it hardly affects water resistance of a resulting barrier backing layer.

The amount of the antistatic agent is preferably 25 parts or smaller relative 5 to 100 parts by mass of the solid content of the barrier backing layer. As for the antistatic properties of the barrier backing layer, the surface electrical resistance thereof may preferably be 10¹⁰ Ωcm or lower.

A method for forming the barrier backing layer is suitably selected depending on the intended purpose without any restriction. The barrier backing layer is preferably formed by applying a coating liquid of the barrier backing layer to a support.

The coating method is suitably selected depending on the intended purpose without any restriction. Examples thereof include blade coating, roll coating, wire bar coating, die coating, and curtain coating.

The thickness of the barrier backing layer is suitably selected depending on the intended purpose without any restriction. It is preferably 0.1 μm to 10 μm, more preferably 0.5 μm to 5 μm.

### <Adhesive Layer>

An adhesive layer, sometime also called a viscous layer, may be provided in the thermosensitive recording medium of the present invention. Such a viscous layer is however not required in the present invention, but instead is only optional.

An adhesive layer may be provided on a surface of the synthetic resin film support layer opposite to the surface over which the protective layer is formed.

The adhesive layer may, for example, help to attach the thermosensitive recording medium to a food package in a possible application of the present invention. The method for forming the adhesive layer is not particularly limited. Examples of the method include common coating methods and laminating methods. The average thickness of the adhesive layer is not particularly limited, may be appropriately selected depending on the intended purpose, and is preferably 0.1 μm or greater but 20 μm or less.

The material of the adhesive layer is not particularly limited and may be appropriately selected depending on the intended purpose. Examples of the material of the viscous layer include urea resins, melamine resins, phenol resins, epoxy resins, vinyl acetate-based resins, vinyl acetate-acrylic-based copolymers, ethylene-vinyl acetate copolymers, acrylic-based resins, polyvinyl ether-based resins, vinyl chloride-vinyl acetate-based copolymers, polystyrene-based resins, polyester-based resins, polyurethane-based resins, polyamide-based resins, chlorinated polyolefin-based resins, polyvinyl butyral-based resins, acrylic acid ester-based copolymers, methacrylic acid ester-based copolymers, natural rubbers, cyano acrylate-based resins, and silicone-based resins. One of these materials may be used alone or two or more of these materials may be used in combination. These materials may be cross-linked by means of a cross-linking agent. The material of the adhesive layer may be a hot-melt type.

### Image Recording Method

An image recording method may be used for recording an image on the thermosensitive recording medium of any of the embodiments of the present invention using an image recording unit, which is any one of a thermal head and a laser.

The thermal head is suitably selected depending on the intended purpose without any restriction regarding the shape, structure and size thereof.

The laser may be selected depending on the intended purpose without any restriction. In one preferred embodiment, a CO₂ laser which emits light having a wavelength of 9.3 μm to 10.6 μm may be used. By using the CO₂ laser which emits light having a wavelength of 9.3 μm to 10.6 μm, a satisfactory laser print image can be obtained without using a photothermal conversion agent such as a phthalocyanine pigment. Other laser types may be used, such as FLDA (Fiber Laser Diode Array).

### EXAMPLES

Hereinafter, the present invention will be specifically described based on Examples and Comparative Examples. However, it should be noted that the present invention is not confined to these Examples in any way. It should be noted that in the following examples, the unit “part(s) means “part(s) by mass” and the unit “%” means “% by mass” unless otherwise specified.

### Example 1

A 10% by mass polyvinyl alcohol aqueous solution (Mowiol 28-99; available from Kuraray Europe GmbH), was coated and dried in this order on thermosensitive recording material (product name: 150LCS-HW, with a thickness of 104 μm, available from Ricoh Company Ltd.) on the opposite side with respect to the thermo-sensitive layer, such that amount of the polyvinyl alcohol remaining attached after drying would be 1.0 g/m² to obtain a thermosensitive recording medium of Example 1. The 150LCS-HW film consists of a biaxially oriented polypropylene (BOPP) support layer, an under layer, a thermo-sensitive colouring layer and a protective layer. In the 150LCS-HW thermosensitive recording material, the BOPP support layer is a PL-100 BOPP layer provided by the supplier Nanya and has a density of 0.78 g/cm³.

### Examples 2 to 9

Thermosensitive recording media of Example 2 to 9 were obtained in the same manner as Example 1 by changing polyvinyl alcohol type (Example 1 to 8 used Poval (registered trademark) brands of PVA available from Kuraray Europe GmbH, an Example 9 amid-modified PVA DM-17 available from JAPAN VAM & POVAL Co. LTD) as shown in following Table 1.

TABLE 1

| | Polyvinyl | | | Poly- |
|---|---|---|---|---|
| | Alcohol | Modification | Saponification | merization |
| | product name | type | percent | degree |
| Example 1 | Mowiol 28-99 | — | 99% | 57500 |
| Example 2 | Poval 3-98 | — | 98% | 13900 |
| Example 3 | Poval 60-98 | — | 98% | — |
| Example 4 | Poval 4-88 | — | 88% | 27800 |
| Example 5 | Poval 56-88 | — | 88% | 82500 |
| Example 6 | Poval 95-88 | — | 88% | 99000 |
| Example 7 | Poval 5-74 | — | 74% | 37600 |
| Example 8 | Poval 25-88KL | Itaconic acid | 88% | — |
| Example 9 | DM-17 | Amide | 96% | — |

### Example 10

### 1) Preparation of Barrier Backing Layer Liquid [A1]

A 20% core shell acrylic emulsion (product name: Bariastar B-2000 available from Mitsui Chemicals, Inc.) (41 parts by mass), a 25% oxazoline crosslinker (product name: Epocros WS-700 available from Nippon Shokubai Co., LTD.) (20 parts by mass) and a 10% polyvinyl alcohol aqueous solution (product name: Mowiol 28-99 available from Kuraray Europe GmbH) (16 parts by mass), and 28 parts by mass of water were mixed and stirred to obtain the barrier backing layer [A1].

### 2) Preparation of Coated Medium

The [A1] liquid was coated and dried in this order on a biaxially oriented polypropylene (BOPP) support (product name: Jindal 100 LH243, with a thickness of 100 μm, available from Jindal Films BV) on the matt treated side such that the amount of [A1] remaining attached after drying would be 1.0 g/m². The 100 LH243 BOPP support layer provided by the supplier Jindal and has a density of 0.74 g/cm³.

This coated support sheet was cured in an environment of 40° C. and 10% relative humidity for 15 hours to obtain Example 10.

### Example 11

The thermosensitive recording medium of Example 11 was obtained in the same manner as in Example 10, except that the BOPP support was replaced by a thermosensitive recording material (product name: 150LCS R, with a thickness of 103 μm, available from Ricoh Industrie France SAS) and [A1] liquid was coated and on the opposite side with respect to the thermo-sensitive layer.

The 150LCS-R film consists of a biaxially oriented polypropylene (BOPP) support layer, a thermo-sensitive colouring layer, and two protective layers. In the 150LCS-R thermosensitive recording material, the BOPP support layer is a 100 LH243 BOPP layer provided by the supplier Jindal and has a density of 0.74 g/cm³.

### Example 12

The thermosensitive recording medium of Example 12 was obtained in the same manner as in Example 11, except that the thermosensitive recording material 150LCS R was replaced by the thermosensitive recording material 150LCS-HW.

### Examples 13 to 15

Thermosensitive recording media of Examples 13 to 15 were obtained in the same manner as Example 12 by changing parts by mass of polyvinyl alcohol in the barrier backing layer as follows:

TABLE 2

| | Polyvinyl | Polyvinyl |
|---|---|---|
| | alcohol | alcohol |
| | (parts | drypercent |
| | by mass) | (%) |
| Example 12 | 16 | 11.1% |
| Example 13 | 8 | 5.9% |
| Example 14 | 41 | 23.8% |
| Example 15 | 82 | 38.5% |

### Example 16

### 1) Preparation of Barrier Backing Layer Liquid [B1]

A 50% copolymer styrene-butadiene (product name: DL 295 available from Trinseo France S.A.S.) (25 parts by mass), a 10% polyvinyl alcohol aqueous solution (product name: Mowiol 28-99 available from Kuraray Europe GmbH) (25 parts by mass), and 50 parts by mass of water were mixed and stirred to obtain the barrier backing layer [B1].

### 2) Preparation of Thermosensitive Recording Medium

The [B1] liquid was coated and dried in this order on thermosensitive recording material (product name: 150LCS-HW, with a thickness of 104 μm, available from Ricoh Company Ltd.) on the opposite side with respect to the thermo-sensitive layer such that the amount of [B1] remaining attached after drying would be 1.0 g/m². Thus, a thermosensitive recording sheet was prepared.

This thermosensitive recording sheet was cured in an environment of 40° C. and 10% relative humidity for 15 hours to produce the thermosensitive recording medium of Example 16.

### Comparative Example 1

The thermosensitive recording medium of Comparative Example 1 was obtained by using same support layer as in Example 1 (150 LCS-HW) but without applying any layer on the side opposite with respect to the thermo-sensitive layer.

### Comparative Examples 2 to 9

The thermosensitive recording media of Comparative Examples 2 to 9 were obtained in the same manner as Example 1 by changing PVA or binder type as indicated in the following table:

TABLE 3

| | Product | | | % by |
|---|---|---|---|---|
| | name | Supplier | Product type | mass |
| Comp. | POVAL | Kuraray Europe | PVA 35% | 10 |
| Ex. 2 | LM-25 | GmbH | saponification | |
| Comp. | NeoRez | DSM Coating | Aliphatic Urethane | 33 |
| Ex. 3 | R-600 | Resin B.V. | dispersion | |
| Comp. | DL 295 | Trinseo France | Copolymer Styrene | 50 |
| Ex. 4 | | S.A.S. | Butadiene | |
| Comp. | HPD40 | Trinseo France | Copolymer Styrene | 50 |
| Ex. 5 | | S.A.S. | Butadiene | |
| Comp. | Joncryl | BASF Netherland | Self-crosslinking | 41 |
| Ex. 6 | FLX 5020 | B.V. | acrylic emulsion | |
| Comp. | Joncryl 2647 | BASF Netherland | Modified acrylic | 47 |
| Ex. 7 | | B.V. | copolymer | |
| Comp. | Bariastar | Mitsui Chemicals, | Core shell acrylic | 20 |
| Ex. 8 | B-2000 | Inc. | emulsion | |
| Comp. | NeoCryl | DSM Coating | Modified acrylic | 45.5 |
| Ex. 9 | A-1095 | Resin B.V. | styrene copolymer | |

### Comparative Example 10

The thermosensitive recording medium of Comparative Example 10 was obtained in the same manner as Example 10, except that [A1] liquid was replaced by a 33% by mass aliphatic urethane dispersion (NeoRez R-600; available from DSM Coating Resins B.V.).

### Comparative Example 11

The thermosensitive recording medium of Comparative Example 11 was obtained in the same manner as Comparative Example 10, provided that BOPP support was replaced by a thermosensitive recording material (150LCS R, with a thickness of 103 μm, available from Ricoh Industrie France) and 33% by mass aliphatic urethane dispersion was coated and on the opposite side with respect to the thermo-sensitive layer.

### Comparative Example 12

### 1) Preparation of Barrier Backing Layer Liquid [C1]

A 20% core-shell acrylic emulsion (product name: Bariastar B-2000 available from Mitsui Chemicals, Inc.) (41 parts by mass), a 25% oxazoline crosslinker (product name: Epocros WS-700 available from Nippon Shokubai Co., LTD.) (20 parts by mass) and 28 parts by mass of water were mixed and stirred to obtain the barrier backing layer [C1].

### 2) Preparation of Thermosensitive Recording Medium

The thermosensitive recording medium of Comparative Example 12 was obtained in the same manner as Example 12 provided that [A1] liquid was replaced by [C1] liquid.

### <Evaluation of Properties of Thermosensitive Recording Media Obtained>

### <Uniformity>

Barrier backing layer uniformity was evaluated after backing barrier layer coating and before drying. Evaluation was carried out according to the evaluation criteria below. For a value of “A”, the barrier layer uniformity is at an acceptable level. For a value of “B”, all other tests cannot be performed.
A: no default of uniformity of coating liquid
B: hole or retraction of coating liquid

### <Curl>

The curl was evaluated by applying a hotmelt glue (RH1, available from UPM Raflatac OY) on the barrier layer of the thermosensitive recording material sample having a width of 5 cm and a length of 5 cm, such that the amount of the hotmelt glue would be 17.5 g/m².

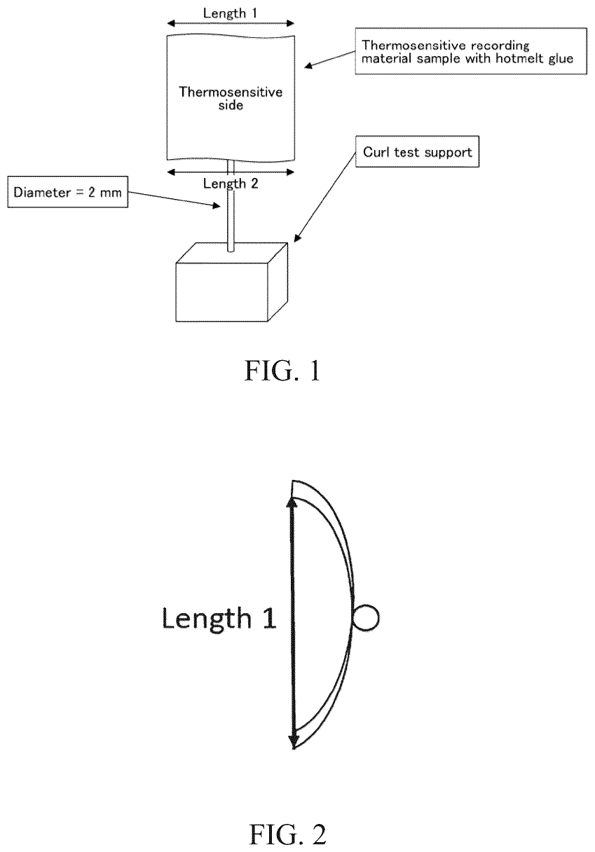

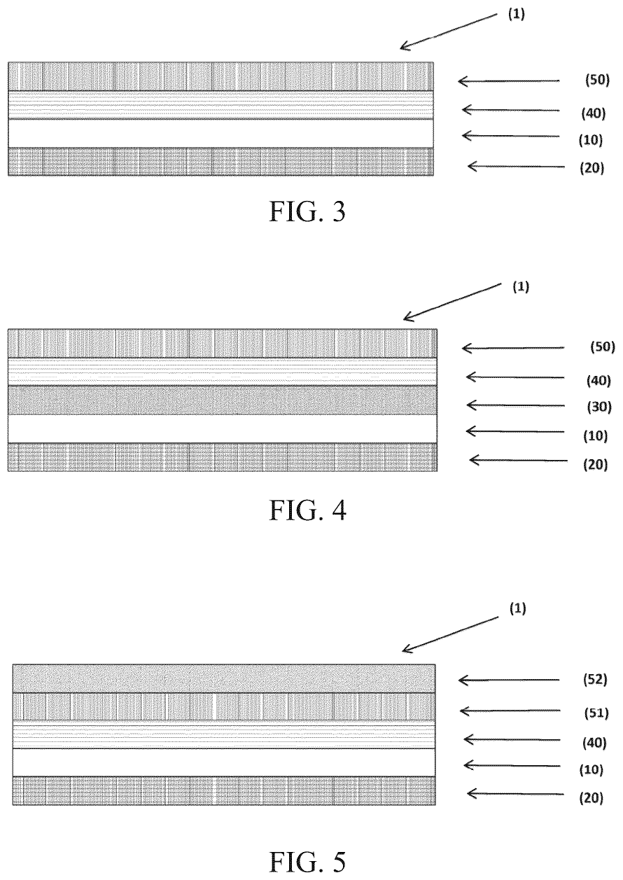

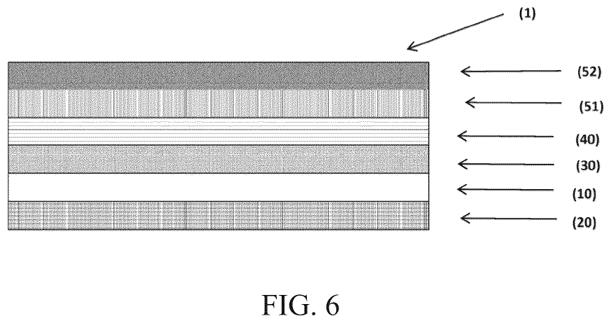

The thermosensitive recording material sample with hotmelt glue is fixed on a stem which is in the middle of the label, and the stem is fixed straight on a support without contact between label and support (see FIG. 1).

The assembly was put in an environment of 50° C. and 70% relative humidity for 72 hours.

After 72 hours, curl was calculated by measuring the distance between the two corners at the top of thermosensitive recording material (Length 1), and the distance between the two corners at the bottom of thermosensitive recording material (Length 2). The final curl value is obtained by calculating an average of Length 1 and Length 2 (see FIGS. 1 and 2)

Evaluation was carried out according to evaluation criteria below. For a value of “A” or “B”, the curl effect is at an acceptable level.
A: Higher than 4.8 cm
B: Between 4.5 cm and 4.8 cm
C: Less than 4.5 cm

### <Barrier Backing Layer Anchorage>

The barrier backing layer anchorage was evaluated by pasting a cellophane tape having a width of 18 mm and a length of 6 cm (Product name CT405 AP-18, available from Nichiban Co, Ltd.) over the barrier backing layer of a thermosensitive recording medium along the direction of the flow of coating and rubbed 10 times with a finger such that no bubbles would be included. Then the tape was removed in steps: i) Slowly stripping the tape to an angle of 90 degrees, ii) Quickly stripping the tape with an angle of 90 degrees. Evaluation was carried out according to evaluation criteria below. For a value of “A” or “B”, the anchorage of the barrier backing layer is at an acceptable level.
A: there was no stripping in either of steps (i) or (ii)
B: there was no stripping in step (i), but there was stripping of the barrier backing layer in step (ii)
C: there was stripping of the barrier backing layer in step (i)

### <Barrier Backing Layer Water Resistance>

The barrier water resistance was evaluated by immerging a thermosensitive recording medium sample having a length of 7 cm (in the direction of coating) and a width of 5 cm, in a 250 ml beaker filled of water during 30 minutes.

After 30 minutes, the sample was taken out the beaker and rubbed 10 ways forward and back with a finger on the barrier backing layer in the direction of the coating. Evaluation was carried out according to the evaluation of the criteria below. For a value of “A”, the water resistance of barrier backing layer is at an acceptable level.
A: no barrier backing layer removal after 10 forward and back finger rubs
B: barrier backing layer removal during finger rubbing

TABLE 4

| | | | Barrier | Barrier Water |
|---|---|---|---|---|
| | Uniformity | Curl | Anchorage | Resistance |
| Example 1 | A | B | C | A |
| Example 2 | A | B | C | A |
| Example 3 | A | B | C | A |
| Example 4 | A | B | C | A |
| Example 5 | A | B | C | A |
| Example 6 | A | B | C | A |
| Example 7 | A | B | C | A |
| Example 8 | A | B | C | A |
| Example 9 | A | B | C | A |
| Example 10 | A | A | A | A |
| Example 11 | A | A | A | A |
| Example 12 | A | A | A | A |
| Example 13 | A | B | B | A |
| Example 14 | A | A | B | B |
| Example 15 | A | A | B | B |
| Example 16 | A | B | C | B |
| Comp. Ex. 1 | NA | C | NA | NA |
| Comp. Ex. 2 | A | C | C | A |
| Comp. Ex. 3 | A | C | A | A |
| Comp. Ex. 4 | B | NA | NA | NA |
| Comp. Ex. 5 | B | NA | NA | NA |
| Comp. Ex. 6 | A | C | A | A |
| Comp. Ex. 7 | A | C | C | A |
| Comp. Ex. 8 | B | NA | NA | NA |
| Comp. Ex. 9 | A | C | C | A |
| Comp. Ex. 10 | A | C | A | A |
| Comp. Ex. 11 | A | C | A | A |
| Comp. Ex. 12 | A | B | A | A |

NA = Not Applicable

### DESCRIPTION OF SYMBOLS

1: Thermosensitive recording medium
10: Synthetic resin support layer
20: Barrier backing layer
30: Under layer
40: Thermosensitive colouring layer
50, 51, 52: Protective layer (multiple protective layers may be present)

The present application is based on and claims priority to European patent application No. 22305146.7, filed on Feb. 10, 2022, the entire contents which are hereby incorporated herein by reference.

1. A thermosensitive recording medium, comprising at least:
a synthetic resin film support layer;
a thermosensitive colouring layer which contains a leuco dye and a developer;
one or more protective layers which is/are laid down on the thermosensitive colouring layer, on the opposite side with respect to the synthetic resin film support layer;
one barrier backing layer which is laid down on the synthetic resin film support layer, on the opposite side with respect to the thermosensitive colouring layer, wherein the barrier backing layer contains a polyvinyl alcohol characterized by a degree of saponification of at least 70%.

2. The thermosensitive recording medium according to claim 1, wherein the quantity of polyvinyl alcohol, expressed as dry weight with respect to 100% dry weight of all the components of the barrier backing layer taken together, is at least 5%.

3. The thermosensitive recording medium according to claim 1, wherein the quantity of polyvinyl alcohol, expressed as dry weight with respect to 100% dry weight of all the components of the barrier backing layer taken together, is at least 10%.

4. The thermosensitive recording medium according to claim 1, wherein the quantity of polyvinyl alcohol, expressed as dry weight with respect to 100% dry weight of all the components of the barrier backing layer taken together, is at most 20%.

5. The thermosensitive recording medium according to claim 1, wherein the quantity of polyvinyl alcohol, expressed as dry weight with respect to 100% dry weight of all the components of the barrier backing layer taken together, is at most 15%.

6. The thermosensitive recording medium according to claim 1, wherein polyvinyl alcohol is used in the barrier backing layer in combination with:
a core-shell type acrylic emulsion comprising a hydrophilic shell polymer including carboxylic acid and a hydrophobic core polymer; and
an oxazoline crosslinker.

7. The thermosensitive recording medium according to claim 1, wherein the synthetic resin film support layer has a thickness of at least 60 μm and at most 105 μm.

8. The thermosensitive recording medium according to claim 1, wherein the synthetic resin film support layer contains biaxially oriented polypropylene (BOPP).

9. The thermosensitive recording medium according to claim 8, wherein the biaxially oriented polypropylene (BOPP) of the synthetic resin film support layer is cavitated BOPP.

10. The thermosensitive recording medium according to claim 9, wherein the cavitated biaxially oriented polypropylene (BOPP) of the synthetic resin film support layer has a density of at least 0.70 g/cm³ and at most 0.80 g/cm³.

11. The thermosensitive recording medium according to claim 1, wherein the synthetic resin film support layer contains two protective layers and.

12. The thermosensitive recording medium according to claim 1, wherein the barrier backing layer contains an antistatic agent.
